(19) United States
(12) Patent Application Publication
(10) Pub. No.: US 2010/0140820 A1
(43) Pub. Date: Jun. 10, 2010

(54) Method of Fabricating Polymer Optical Fiber Preform For Polymer Optical Fibers

(75) Inventors: Hwa-Yaw Tam, Hong Kong (CN); Gui Yao Zhou, Hong Kong (CN); Chi Fung Pun, Hong Kong (CN)

Correspondence Address: WILKINSON & GRIST, 6TH FLOOR, PRINCE''S BUILDING, CHATER ROAD, CENTRAL, HONG KONG, HK

(73) Assignee: Hong Kong Polytechnic University, Hong Kong (CN)

(21) Appl. No.: 12/329,545

(22) Filed: Dec. 6, 2008

(51) Int. Cl. B29D 11/00

(52) U.S. Cl. 264/1.24

(57) ABSTRACT

A method of fabricating a polymer optical fiber preform may include pre-polymerizing a monomeric reactant mixture, filling the mixture into a mould, and polymerizing the mixture into an optical fiber preform. The method may also include removing the mould from the preform.

### BACKGROUND

Polymer optical fibers (POF) are used as a transmitting medium of optical signals in fibers, and find wide domestic and business applications. Recently, there has been a growing interest in using POFs for biophonics applications due to their advantages over silica glass fibers, such as being biocompatible with polymers and not breaking into shards. Traditional methods of fabricating a POF involve preparing a polymer optical fiber preform and then drawing the preform into the POF. Conventional methods for fabricating polymer optical fiber preforms include interfacial gel prepolymerization techniques, extrusion techniques, and hole-drilling techniques.

Step-index polymer optical fiber preforms are typically fabricated using the following method: A monomer mixture is injected into a glass tube, and the glass tube is rotated around its axis in an oven. The monomers then start to polymerize along an inner wall of the glass tube due to the centrifugal force, and a poly(methyl methacrylate) (PMMA) tube is obtained. A monomer mixture serving as the core material is then injected into the PMMA tube, which is heated by an external heat source. However, as with the extrusion technique, the air holes of the POF fabricated using this method may easily collapse, because the polymer optical fiber preform is often not rigid enough to support the structure when it leaves the oven. This technique is not appropriate for the fabrication of microstructure POFs, where many air holes in either periodic or nonperiodic arrangements run along the length of the preforms. Microstructure POFs are usually fabricated by drilling holes in PMMA rods. However, the resulting inner surfaces of the holes made by this technique are not smooth and may introduce significant scattering loss to optical signals.

Consequently, it is desirable to have an improved method of making a polymer optical fiber preform that is convenient for fabricating optical fibers that can have a variety of channel arrangements. It is also desirable to have a polymer optical fiber preform that has optimal polymerization, with minimal trapped bubbles, and that has smooth channel surfaces to minimize scattering loss in the optical fiber subsequently drawn from the preform.

### BRIEF SUMMARY

According to one aspect, a method of fabricating a polymer optical fiber preform may include pre-polymerizing a monomeric reactant mixture, filling the mixture into a mould, and polymerizing the mixture into an optical fiber preform. The method may also include removing the mould from the preform.

### BRIEF DESCRIPTION OF THE DRAWINGS

FIG. 1A depicts a single capillary inside a glass tube.

FIG. 1B depicts a plurality of capillaries of equal outside diameters inside a tube.

FIG. 1C depicts a plurality of capillaries of equal outside diameters inside a tube with an empty center.

FIG. 1D depicts a plurality of capillaries of different outside diameters inside a tube.

FIG. 2 depicts a mould for making a polymer optical fiber preform.

FIG. 3 depicts a fabricated multi-channel polymer optical fiber preform.

FIG. 4 depicts a fabricated single channel polymer optical fiber preform.

FIG. 5 depicts a graph of the actual and setting temperature for polymerization of MMA monomers.

FIG. 6 depicts a graph of the relationship between polymerization rate of MMA and temperature.

FIG. 7 depicts a POF fabricated without pre-polymerization.

### DETAILED DESCRIPTION

Reference will now be made in detail to a particular embodiment of the invention, examples of which are also provided in the following description. Exemplary embodiments of the invention are described in detail, although it will be apparent to those skilled in the relevant art that some features that are not particularly important to an understanding of the invention may not be shown for the sake of clarity.

Furthermore, it should be understood that the invention is not limited to the precise embodiments described below, and that various changes and modifications thereof may be effected by one skilled in the art without departing from the spirit or scope of the invention. For example, elements and/or features of different illustrative embodiments may be combined with each other and/or substituted for each other within the scope of this disclosure and appended claims. In addition, improvements and modifications which may become apparent to persons of ordinary skill in the art after reading this disclosure, the drawings, and the appended claims are deemed within the spirit and scope of the present invention.

A method of fabricating a polymer optical fiber preform may include pre-polymerizing a monomeric reactant mixture, filling the mixture into a mould, and polymerizing the mixture into an optical fiber preform. The method may also include removing the mould from the preform.

The first step may include pre-polymerizing a monomeric reactant mixture. The mixture may be configured to become the cladding material of the fabricated POF. The mixture may include a monomer, an initiator reagent, a chain transfer reagent, and a dopant. The dopant may include photosensitive materials, which may be used in POF for polymer optical fiber grating.

For example, the monomer may be methyl methacrylate (MMA) or 1,4-butylene vinyl ether perfluoride (C₆F₁₀O); the initiator reagent may be lauroyl peroxide (LPO); the chain transfer reagent may be 1-butanethiol (BT); and the dopant may be trans-4-stilbenemethanol. The mixture may contain 99.0 to 99.95 percent of moles of the monomer, 0.01 to 0.05 percent of moles of the initiator reagent, and 0.01 to 1.0 percent of moles of the chain transfer reagent. For example, the molar ratio of monomer to the initiator reagent to the chain transfer reagent may be 99.72:0.03:0.25.

The monomer mixture may be poured into a container. The container may be covered with aluminum foil to prevent thermal volatilization of the mixture. The mixture may then be heated and stirred for around 90 minutes at the temperature of 85° C. in a heated water bath to pre-polymerize the mixture, until the mixture becomes viscous and is contracted in volume by around 10 percent. In order to avoid explosive polymerization, the diffusion movement of the macromolecular free radicals may be accelerated, and the temperature may be prevented from rising using a stirring method. The mixture may then be rapidly cooled to room temperature.

The viscosity of monomer mixture may increase gradually with the polymerization reaction. This may affect the diffusion movement of the macromolecular free radicals. The rate of chain termination may be reduced, but the rate of polymerization may be kept constant, because the smaller molecular monomers may be unaffected by viscosity. Since polymerization of monomers may be an exothermic chemical reaction, and polymers typically are poor heat conductors, the temperature of the mixture may rise fleetly with the polymerization reaction. The higher temperature may make the rate of polymerization reaction to increase further, and may cause explosive polymerization. This may result in a mass of bubbles appearing in the POFs when the monomers are vaporized under the high temperature, as depicted in FIG. 7. This undesired phenomenon may affect the refractive-index distribution of the POFs. Pre-polymerization of the mixture may significantly alleviate this undesired effect to the POF.

While not being bound by theory, it is believed that the total polymerization rate of monomers can be expressed as:

$${R}_{p} = {{{k}_{p} ( \frac{{k}_{d}}{{k}_{t}} )}^{1 / 2} [ M ] [ I ]}^{1 / 2} = {k [ M ] [ I ]}^{1 / 2} \qquad ( 1 )$$

where Rₚ is the total polymerization rate; kₜ is the terminal rate coefficient of chain; kₚ is the polymerized rate coefficient of monomers; k_{d} is the decomposed rate coefficient of initiator; [I] is the concentration of the initiator; and [M] is the concentration of the monomer.

According to the principles of polymerization, the viscosity of the monomer mixture increases with the conversion rate increasing, resulting in a gelling effect. This decreases the diffusion movement of macromolecular free radicals. However, the diffusion of monomer molecules is not as strongly affected. Therefore, kₜ is reduced while kₚ may be relatively constant. From equation (1), Rₚ of the monomers may increase rapidly with the increase of

$$\frac{{k}_{p}}{\sqrt{{k}_{t}}} .$$

According to the Arrhenius Equation:

$$k = A exp ( - \frac{E}{RT} ) \qquad ( 2 )$$

In this equation,

$$A = {{A}_{p} ( \frac{{A}_{d}}{{A}_{t}} )}^{1 / 2} ,$$

where Aₚ is the pre-exponential constant of the polymerized rate, A_{d} is the pre-exponential constant of the decomposed rate, and Aₜ is the pre-exponential constant of the termination rate; R is the molar gas constant; and

$$E = {E}_{p} + \frac{1}{2} {E}_{d} - \frac{1}{2} {E}_{t} ,$$

where Eₚ is polymerization energy, E_{d} is the decomposed energy of initiator, and Eₜ is terminal energy of chain.

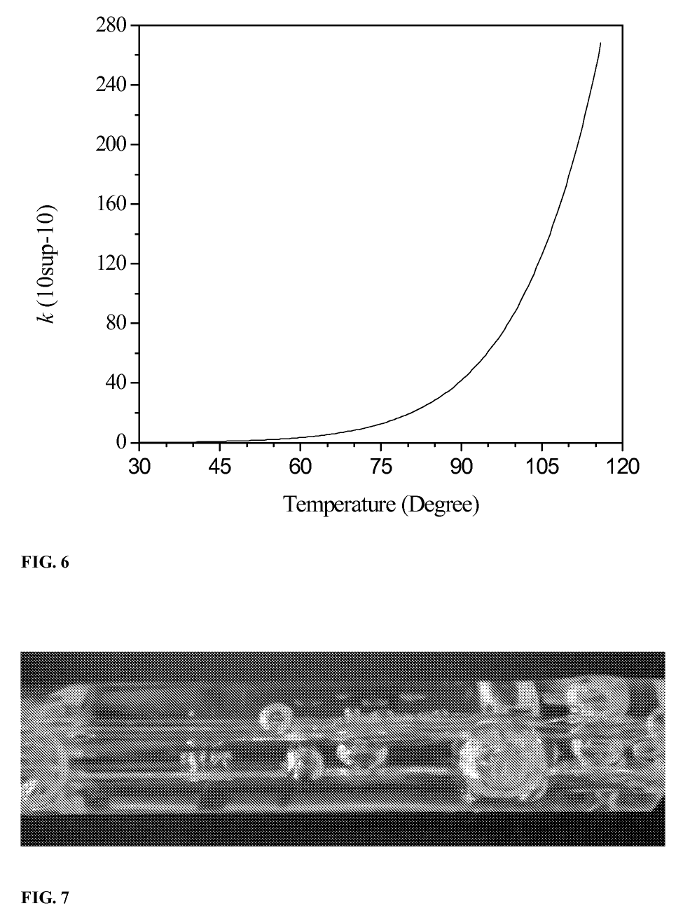

The relation between polymerization rate (k) of MMA and the temperature when using LPO as initiator is depicted in FIG. 6. FIG. 6 shows the polymerization rate (k) of MMA increases rapidly with rising temperature. For example, the polymerization rate (k) of MMA increases by around 2.5 times when the temperature changes from 60° C. to 70° C. The polymerization reactant came close to a stop when the temperature was below 60° C.

The second step may include preparing a mould for polymerizing the monomer mixture. The mould may include a tube 20 and one or more capillaries 22 inserted inside the tube 20, as depicted in FIG. 2. The tube 20 may include a spacing 34 to receive the monomer mixture. For example, the tube 20 may be a glass tube, and the capillaries 22 may be silica glass capillaries. The glass tube and capillaries may furnish a smooth surface to the fabricated POF, as well as decrease its scattering loss.

The glass tube may include an 18-millimeter inner diameter, and the silica glass capillaries may include a 0.8-millimeter outer diameter. One of the ends 24 of the capillaries may be sealed to prevent the monomeric mixture from entering the capillaries. For example, an oxyhydrogen flame may be used to seal off the ends. The mould may also include a stopper 32 placed within the glass tube to maintain the position of the capillaries 22 inside the glass tube 20. The stopper may include metal or plastics such as polyoxymethylene or polytetrafluoroethylene. For example, two polytetrafluoroethylene stoppers at both ends of the glass tube may be used.

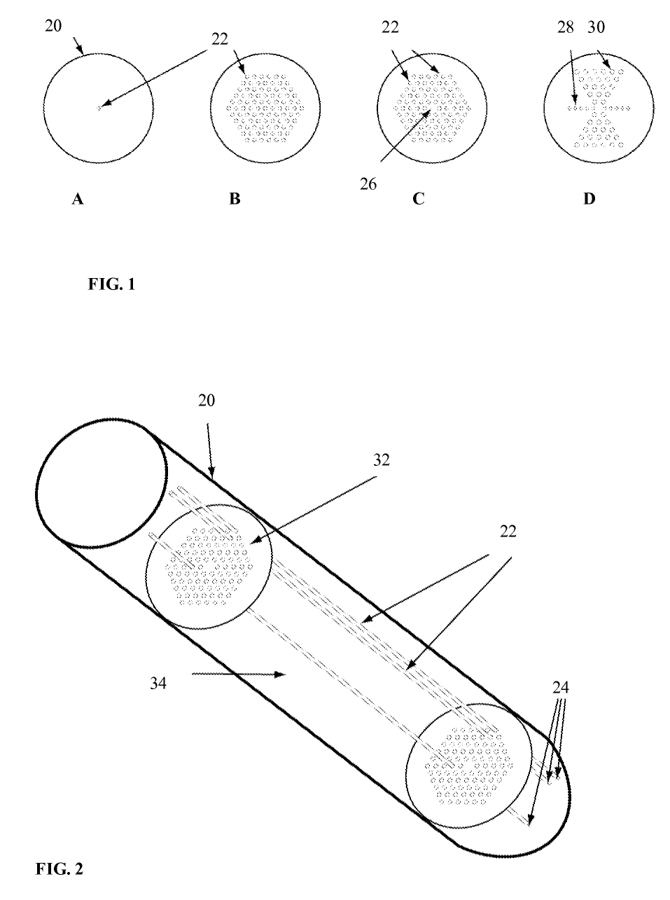

Examples of the various arrangements of the glass capillaries inside the glass tube are depicted in FIGS. 1A to 1D. FIG. 1A depicts a single capillary 22 inside a tube 20. FIG. 1B depicts a plurality of capillaries 22 having equal outside diameters inside a tube. FIG. 1C depicts a plurality of capillaries 22 having equal outside diameters inside a tube but with an empty center 26. FIG. 1D depicts a plurality of capillaries 28 and 30 having different outside diameters inside a tube. Other arrangements may be also included according to one of ordinary skill in the art.

Alternatively, a second embodiment of preparing the mould may include using polymer cords instead of the capillaries. The polymeric cords may include wires with polymeric coating. The polymeric material of the cords may be sufficiently rigid and may have smooth surfaces so that the cords may be easily removed. The polymeric material may also be stable at the temperature of processing the polymer mixture so that the material may not contaminate the mixture. Any suitable polymeric material known to one of ordinary skill in the art may be used.

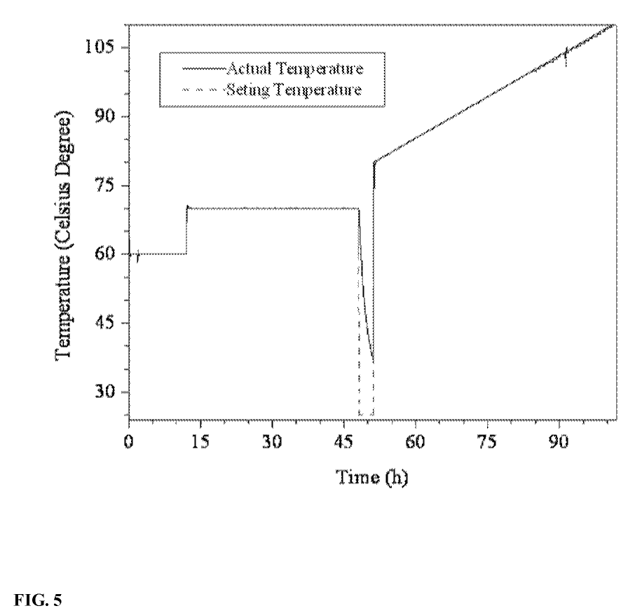

The third step may include filling the mixture into the mould and polymerizing the mixture into an optical fiber preform. The reactant mixture may be first poured into the mould, and the mould may then be put into an oven for polymerization. A computer program may be used to control the oven and to modulate the required temperature profile for achieving the optimum polymerization of the mixture. Since the viscosity of the reactant mixture may be high, gelling may occurr if the polymerization is conducted at a high temperature. The actual and setting temperatures for MMA monomers in an example polymerization are depicted in FIG. 5.

The polymerization may begin at a temperature of about 60° C. for approximately 12 hours to prevent explosive polymerization. The temperature may then be kept at 70° C. for approximately 35 hours to ensure the conversion of monomers to polymers reaches equilibrium. Subsequently, the temperature may be lowered to room temperature to prevent the polymer from adhering to the glass tube. Finally, the temperature may be gradually and linearly increased from 80° C. to 110° C. for 110 hours to achieve complete polymerization. One advantage to polymerizing under these conditions is the significant reduction in deformation or shrinkage of the optical fiber preform due to volume contraction. Therefore, the original structure of the optical fiber may be maintained.

The fourth step may include removing the mould from the fabricated polymer optical fiber preform. The polymer optical fiber preform may be taken out of the oven after polymerization, with the capillaries embedded. The tube and the stoppers may be removed, and the capillaries inside the preform may then be etched away by immersing the polymer optical fiber preform in an acid until all the glass and capillaries in the preform have been dissolved. For example, the polymer optical fiber preform may be immersed in 25 percent hydrofluoric acid for around two days at room temperature until the inside glass capillaries are fully removed. The thin wall of the glass capillaries may allow them to be dissolved when exposed to the acid.

In the embodiment where the mould includes polymer cords, the cords may be removed from the fabricated polymer optical fiber preform by pulling the cords out of the polymerized mixture, and leaving the air-holes in the polymerized mixture with smooth inner surfaces.

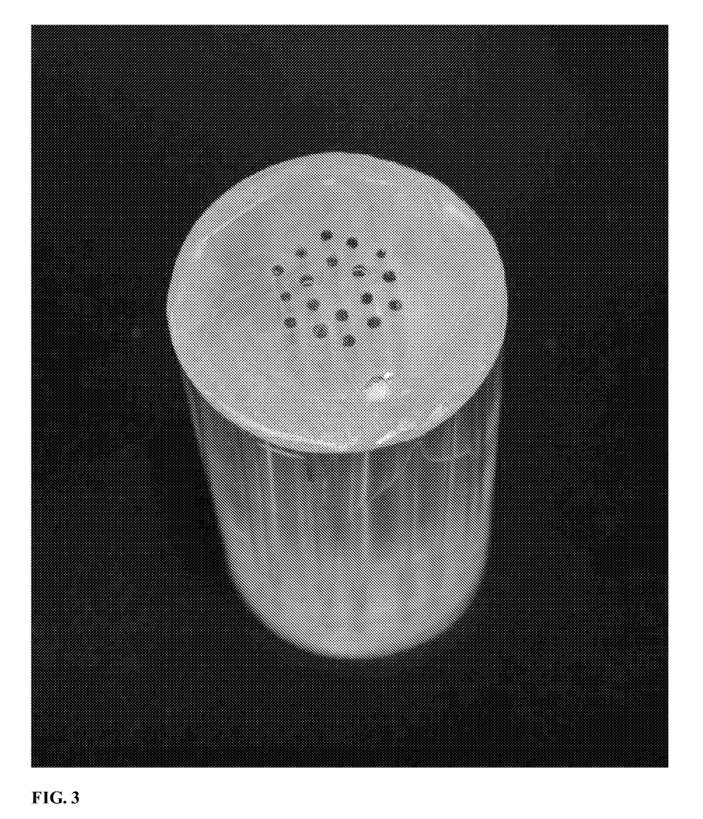

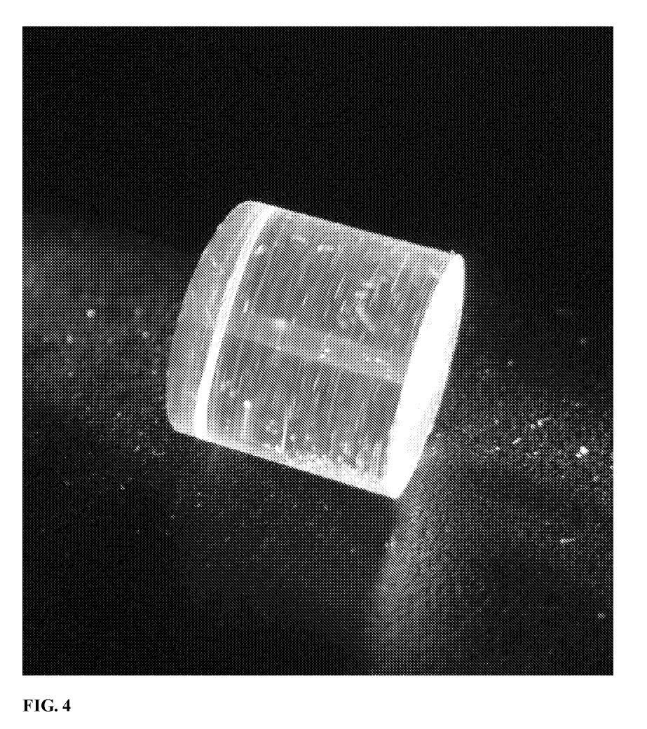

Single channel and multi-channel polymer optical fiber preforms with varying channel sizes may be fabricated using this method by varying the mould structure. A multi-channel polymer optical fiber preform fabricated from using a mould similar to the one depicted in FIG. 1C is depicted in FIG. 3. A single channel polymer optical fiber preform fabricated from using a mould similar to the one depicted in FIG. 1A is depicted in FIG. 4.

The polymer optical fiber preform as fabricated using this method may avoid trapped bubbles in the POF subsequently drawn from the preform, and may achieve an optimum degree of polymerization. Moreover, the surfaces of the channels may maintain their structural integrity and provide smooth channel surfaces, which may significantly reduce scattering loss during use.

While the polymer optical fiber preform and methods have been described, it should be understood that the polymer optical fiber preform and methods are not so limited, and modifications may be made. The scope of the polymer optical fiber preform and methods are defined by the appended claims, and all devices and methods that come within the meaning of the claims, either literally or by equivalence, are intended to be embraced therein.

1. A method of making a polymer optical fiber preform, comprising:
pre-polymerizing a monomeric reactant mixture;
filling said mixture into a mould; and
polymerizing said mixture into an optical fiber preform.

2. The method of claim 1, wherein said pre-polymerizing comprises heating and stirring said mixture in a heated bath until the mixture contracts by 10 percent in volume.

3. The method of claim 1, wherein said mixture comprises a monomer, an initiator, and a chain transfer reagent.

4. The method of claim 3, wherein said mixture comprises from 99.5 to 99.95 mole percent of said monomer.

5. The method of claim 3, wherein said monomer comprises methyl methacrylate.

6. The method of claim 3, wherein said monomer comprises 1,4-butylene vinyl ether perfluoride.

7. The method of claim 3, wherein said mixture comprises from 0.01 to 0.05 mole percent of said initiator.

8. The method of claim 3, wherein said initiator comprises lauroyl peroxide.

9. The method of claim 3, wherein said mixture comprises from 0.01 to 0.5 mole percent of said chain transfer reagent.

10. The method of claim 3, wherein said chain transfer reagent comprises 1-butanethiol.

11. The method of claim 3, wherein said mixture further comprises a dopant.

12. The method of claim 11, wherein said dopant comprises trans-4-stilbenemethanol.

13. The method of claim 1, wherein said mould comprises one or more polymeric cords.

14. The method of claim 13, wherein said polymeric cords comprise wires with polymeric coating.

15. (canceled)

16. The method of claim 1, wherein said mould comprises a tube and one or more capillaries inside said tube.

17. The method of claim 16, wherein said mould comprises a single capillary inside said tube.

18. The method of claim 16, wherein said capillaries have one of the ends sealed off.

19. (canceled)

20. The method of claim 1, wherein said polymerizing comprises heating said mixture in an oven.

21. The method of claim 20, wherein said polymerizing further comprises increasing the temperature in said oven linearly from 80° C. to 110° C.

22. The method of claim 16, further comprising removing said capillaries from within said optical fiber preform by etching them away using an acid, wherein said capillaries are made of silica glass.

23. (canceled)

24. (canceled)
